(19) United States
(12) Patent Application Publication
(10) Pub. No.: US 2006/0221374 A1
(43) Pub. Date: Oct. 5, 2006

(54) Scan job priority determining systems and methods

(75) Inventors: Daryl D'Entrecasteaux, Cambridge (GB); Michael Barrett, Fairport, NY (US); Cynthia Moskal, Walworth, NY (US); Keith S. Karn, Avon, NY (US); Kari Poysa, Macedon, NY (US)

Correspondence Address: OLIFF & BERRIDGE, PLC., P.O. BOX 19928, ALEXANDRIA, VA, 22320, US

(73) Assignee: XEROX CORPORATION, Stamford, CT (US)

(21) Appl. No.: 11/095,579

(22) Filed: Apr. 1, 2005

(51) Int. Cl. G06K 15/00

(52) U.S. Cl. 358/1.14; 358/1.15

(57) ABSTRACT

Systems, methods, and programs determine a priority of a job on a network. The job includes image data optically captured by a device in communication with the network. The systems, methods, and programs determine at least one job attribute or user attribute of a user associated with the job and assigning the job a priority based one the at least one job attribute or user attribute.

### BACKGROUND

1. Related Technical Fields

Related technical fields include systems and methods of determining scan job priority.

2. Related Art

In conventional image processing networks, network scan jobs consist of image data that is routed from a scanner through a server to one or more processing devices or programs, such as, for example, a printer, a server, a graphics program, a facsimile machine, a facsimile program and/or any other device or program capable of handling the image data. The order in which the image data for each scan job is processed at the server is dependent upon the order in which the image data is scanned on the device. The server then processes the scan jobs, e.g., routes the image data to the one or more processing devices or programs, based on the order in which the server receives the jobs.

### SUMMARY

The above-described conventional image processing networks thus process each job in order, irrespective of the attributes of the job or the attributes of a user who submitted the job. The result being that a recently submitted job containing a small amount of image data may take an unexpectedly long time for the server to process if one or more larger jobs were submitted prior to the small job. This is the case even if the user who submitted the small job is, for example, a user that may deserve a higher priority based on one or more characteristics of the user.

Accordingly, it is beneficial to consider one or more attributes of a user and/or a scan job and adjust the overall order in which the scan jobs are processed accordingly.

Various implementations of the principles described herein include a method for determining a priority of a job on a network. The job may include image data optically captured by a device in communication with the network. The method may include the steps of determining at least one user attribute of a user associated with the job; and assigning the job a priority based on the at least one user attribute.

Various implementations of the principles described herein include a system for determining a priority of a job on a network. The job may include image data optically captured by a device in communication with the network. The system may include a controller that determines at least one user attribute of a user associated with the job and assigns the job a priority based on the at least one user attribute.

Various implementations of the principles described herein include a storage medium storing a set of program instructions executable on a data processing device and usable to determine a priority of a job on a network. The job may include image data optically captured by a device in communication with the network. The instructions may include instructions for determining at least one user attribute of a user associated with the job and instructions for assigning the job a priority based on the at least one user attribute.

### BRIEF DESCRIPTION OF THE DRAWINGS

Exemplary implementations will now be described with reference to the accompanying drawings, wherein:

FIG. 1 shows a method of assigning a user to a priority group according to an exemplary implementation of the principles described herein;

FIG. 2 shows a method of assigning a user to a priority group according to an exemplary implementation of the principles described herein;

FIGS. 3 and 4 shows a method of assigning a job priority within a group according to an exemplary implementation of the principles described herein;

FIG. 5 shows a method of processing a job and outputting information according to an exemplary implementation of the principles described herein; and

FIG. 6 shows a functional block diagram of an exemplary system for determining the scan job priority.

### DETAILED DESCRIPTION OF EXEMPLARY IMPLEMETATIONS

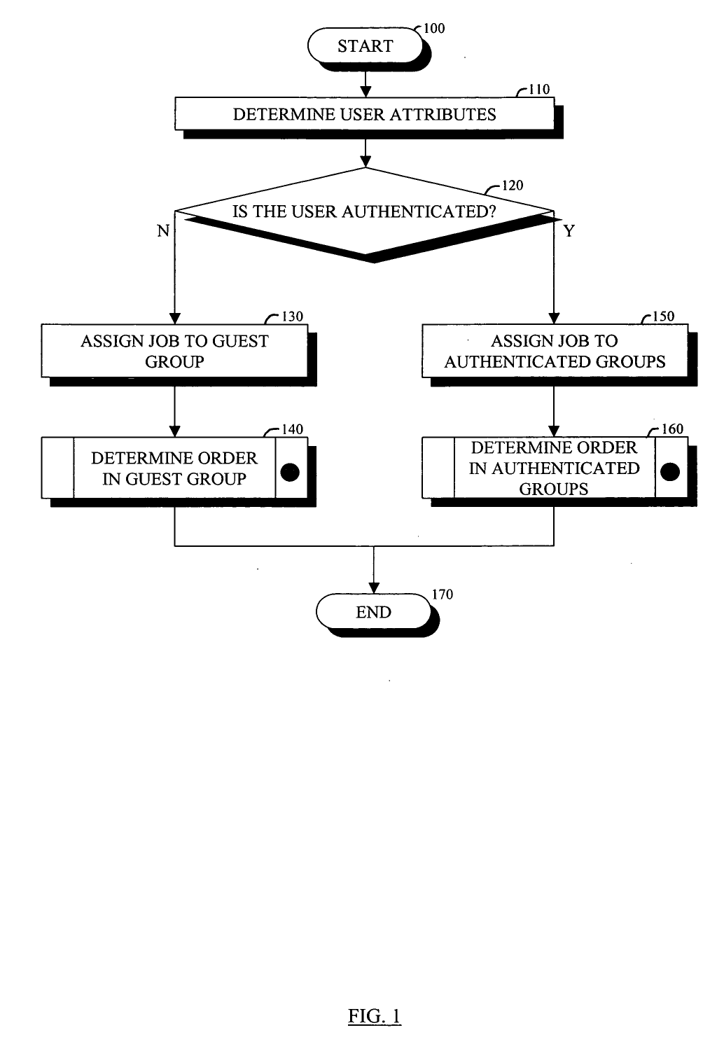

FIG. 1 shows an exemplary method of assigning a user to a priority group. For the purpose of the exemplary method, it is assumed that a user of an image-processing network has input image data into the image-processing network, for example, by scanning an image on a device communicating with the network.

The exemplary method begins in step 100 and continues to step 110. In step 110, the user's attributes are determined. The user's attributes may be determined, for example, based on a user's logging into the network, entering an access code on a device in communication with the image-processing network, and/or swiping an access card on a device in communication with the image-processing network. The user's attributes may be determined, for example, by the users e-mail address.

The user's attributes may be inferred from, for example, a location of the device in which the image data was input into the network (determined for example by a device's network IP address). For example, if the image data was input to the image-processing network on a scanner in a certain employee's office, it may be assumed that the user has the attributes of that employee. If the image data was input to the image-processing network on a public multi-function imaging device in a public research area, it may be assumed that the user has the attributes of a guest.

In step 120, it is determined whether the user is authenticated. If the user is authenticated, operation continues to step 130. If the user is not authenticated, operation jumps to step 150. A user may be considered authenticated based on the users attributes. An authenticated user may be a user, for example, who is registered with the network in some manner or is otherwise assumed to be registered.

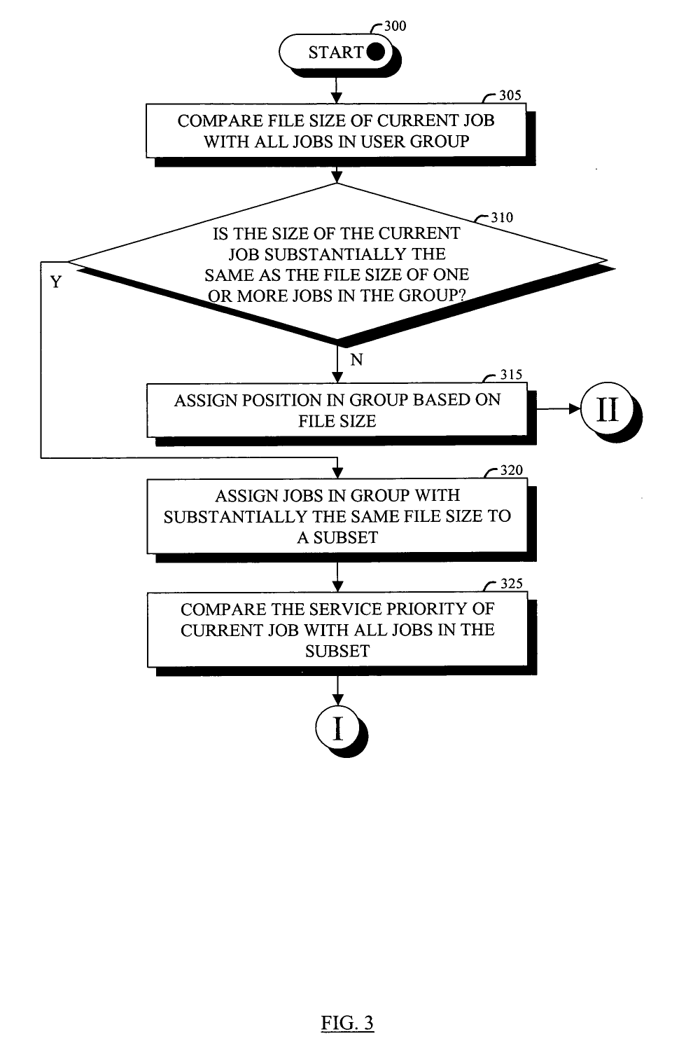

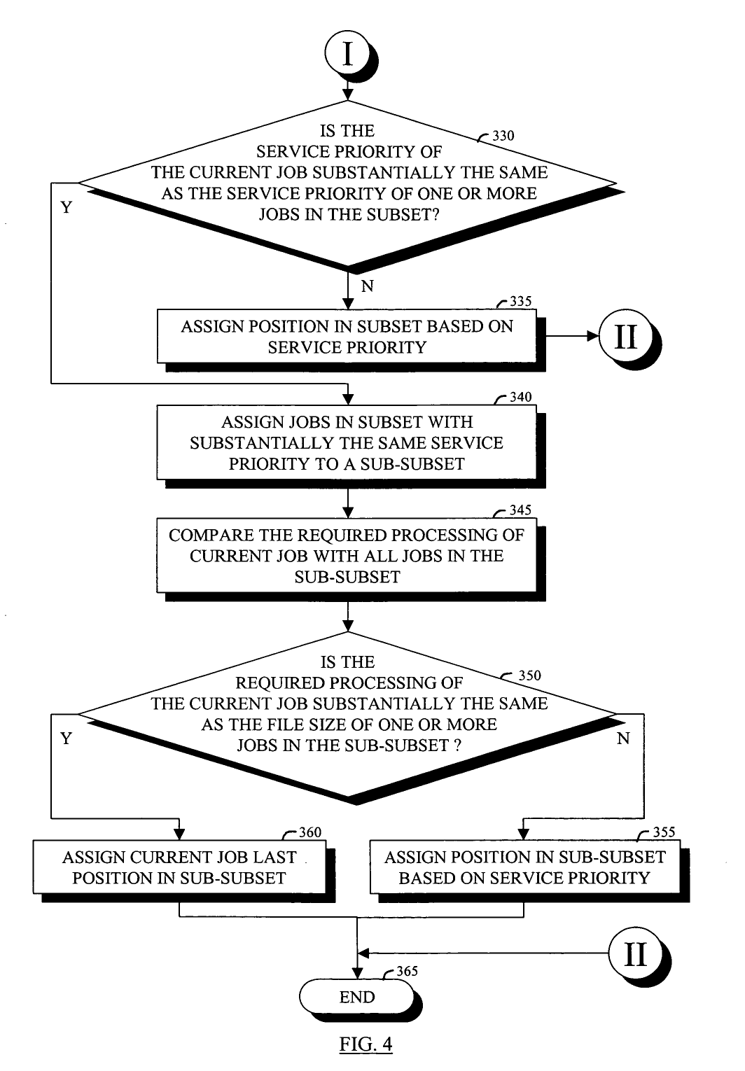

In step 130, the user is assigned to a guest group. Then, in step 140, the user's job is assigned an order within the guest group of jobs. The order of the user's job within the guest group may be assigned, for example, by the exemplary method of assigning a job priority within a group shown in FIGS. 3 and 4. Operation continues to step 170.

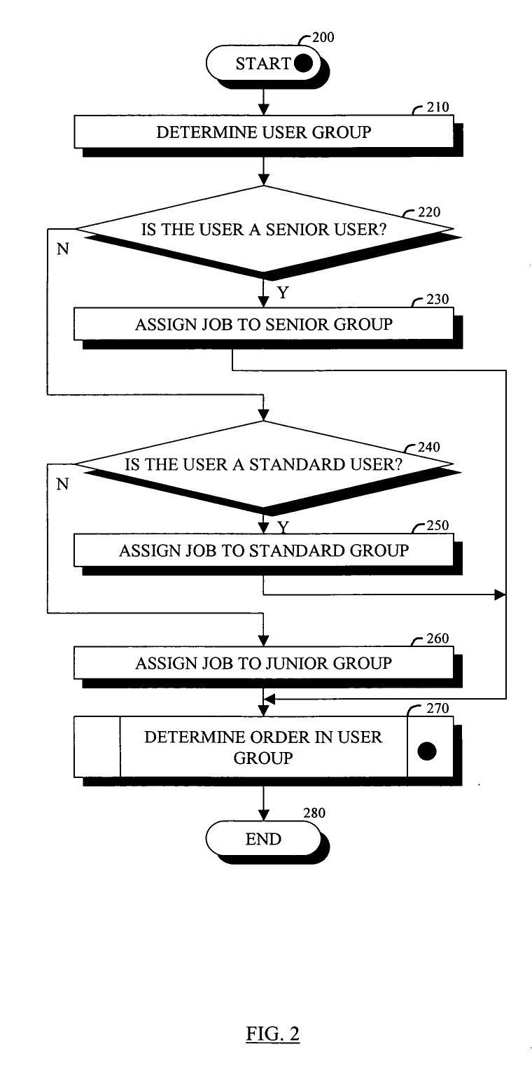

In step 150, the user is assigned to one or more authenticated groups. Then, in step 160, the user's job is assigned an order within the one or more authenticated groups. The order of the user's job within the one or more authenticated groups may be assigned, for example, by the exemplary method of assigning a user to a priority group shown in FIG. 2 and/or the exemplary method of assigning a job priority within a group shown in FIGS. 3 and 4. Operation continues to step 170, where operation of the method ends.

By considering and assigning a user's job an order based on attributes of the user, such as a group to which the user belongs, a server of the image-processing network may take into consideration the user's group in determining an order in which the current jobs will be processed. For example, authenticated user's jobs may be assigned a higher priority than guest's jobs. Thus, an authenticated user's job will be routed to the proper output device and subsequently output before a guest's job, thereby allowing authenticated users to more efficiently utilize the image-processing network.

FIG. 2 shows an exemplary method of assigning a user to a priority group. For the purpose of the exemplary method, it is assumed that a user of an image-processing network has input image data into the image-processing network and been assigned to a group, for example the authenticated user groups, which includes a number of groups, for example, senior users, standard users, and junior users.

Operation of the method begins in step 200 and continues to step 210 where the users attributes are evaluated in order to determine the user's group. The user's attributes may, for example, be stored on a memory in communication with the image-processing network. Thus, based on one or more pieces on information associated with the job, the user's attributes may be accessed and the users group may be determined. Such pieces of information may include, for example, a user's login information, a user's access code, a users e-mail address, a location of an input device, or any other information that may be used to identify or predict one or more characteristics of a user. This information, for example, may then be used to query the stored user attributes and determine or predict the attributes of the user.

In step 220, it is determined whether the user is a senior user. If the user is a senior user, operation continues to step 230. If the user is not a senior user, operation jumps to step 240. In step 230, the user is assigned to the senior user group and operation jumps to step 270.

In step 240, it is determined whether the user is a standard user. If the user is a standard user, operation continues to step 250. If the user is not a standard user, operation jumps to step 260. In step 250, the user is assigned to the senior user group and operation jumps to step 270. In step 260, the user is assigned to the junior user group. Operation jumps to step 270.

In step 270, the order of the user's job is determined within the assigned user group. The order of the user's job within the assigned user group may be determined, for example, by the exemplary method of assigning a job priority within a group shown in FIGS. 3 and 4. Operation continues to step 280 where operation of the method ends.

By considering and assigning an authenticated user's job to a smaller group within the authenticated user group, a server of the image-processing network may take into consideration the user's smaller group in determining an order in which the current jobs will be processed. For example, senior user's jobs may be assigned a higher priority than standard user or junior user jobs. Thus, a senior user's job will be routed to the proper output device and subsequently output before standard user or junior user jobs thereby allowing senior users to more efficiently utilize the image-processing network as well as affording senior users the priority associated with their senior status.

FIGS. 3 and 4 show an exemplary method of assigning a job priority within a group. For the purpose of the exemplary method, it is assumed that a user of an image-processing network has input image data (the current job) into the image-processing network and been assigned to a group.

Operation of the method begins in step 300 and continues to step 305 where it is determined whether the data size of the current job is substantially the same as the data size of one or more jobs in the group. If the data size of the current job is not substantially the same as the data size of one or more jobs in the group, operation continues to step 315. If the data size of the current job is substantially the same as the data size of one or more jobs in the group, operation jumps to step 320. In step 315, the current job is assigned a position within the group based on its data size. For example, the smaller data size jobs may have priority over the current job and the current job may have priority over the larger data size jobs. Operation continues to step 365.

In step 320, the current job and the jobs with substantially the same data size as the current job are assigned to a subset. Then, in step 325, the service priority of the current job is compared with the service priority of the jobs in the subset. Next, in step 330, it is determined whether the service priority of the current job is substantially the same as the service priority of one or more jobs in the subset.

For example, all or part of the image processing network may have a predefined service priority, for example, defined by a network administrator and based on the individual characteristics of the network, such as, for example, primary use of the network, typical use of the network, typical output of the network, hardware and/or software capabilities of the network, and/or any other characteristics deemed relevant by an administrator, for example, to fine tune job priority. An example of service priory might be 1) e-mail, 2) fax jobs, and 3) network scanning, where image data for use in an e-mail would take priority over image data for use in a facsimile which would take priority over image data for use in, or as a result of, other network scanning operations.

If the service priority of the current job is not substantially the same as the service priority of one or more jobs in the subset, operation continues to step 335. If the service priority of the current job is substantially the same as the service priority of one or more jobs in the subset, operation jumps to step 340. In step 335, the current job is assigned a position within the group based on its service priority and operation jumps to step 365. In step 340, the current job and the jobs in the subset with substantially the same service priority are assigned to a sub-subset. In step 345, the current job and the jobs in the same sub-subset are compared to determine the required processing.

In step 350, it is determined whether the required processing of the current job is substantially the same as one or more of the jobs in the sub-subset. If the required processing of the current job is not substantially the same as one or more of the jobs in the sub-subset, operation continues to step 355. If, the required processing of the current job is substantially the same as one or more of the jobs in the sub-subset, operation jumps to step 360. The required processing of a job may be, for example, a measure of the amount of operations that must be performed on the data prior to its being output and/or a length of time that the processing will take.

In step 355, the position of the job in the sub-subset is assigned based on its required processing and operation jumps to step 365. In step 360, the job is assigned the lowest priority within the sub-subset.

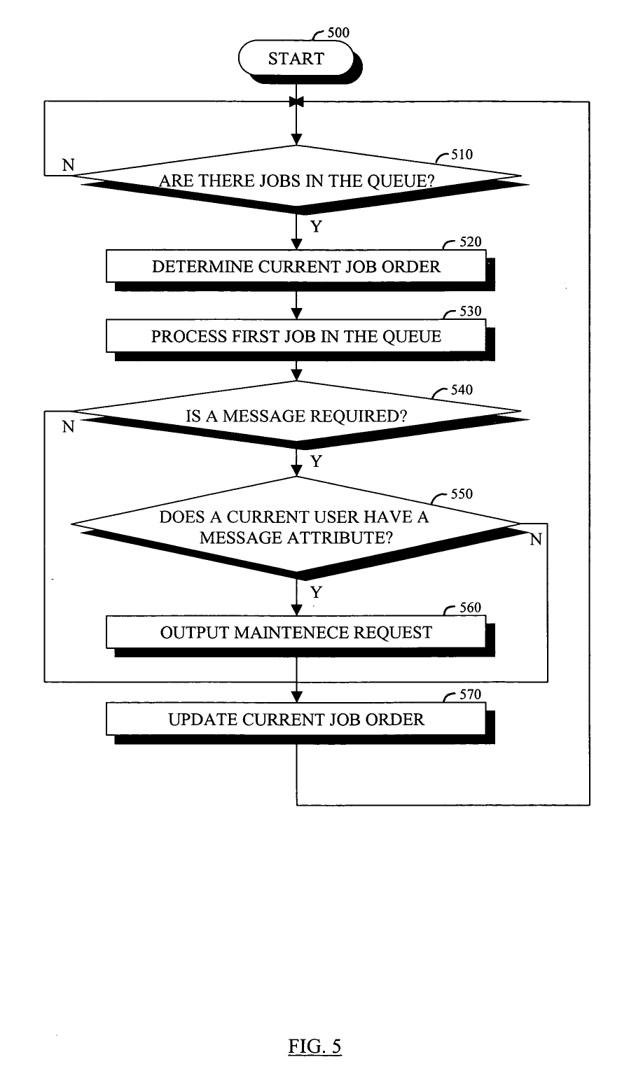

A job's priority may be determined, for example, according to one or more of the above described exemplary methods. While the priority of various input jobs is being determined, jobs may be being processed according to the determined priority. However, because each job has one or more user attributes associated with it, information relevant to the user may be output to the user by a device that outputs a product of the user's job. This may be done, for example, according to the exemplary method of processing a job and outputting information shown in FIG. 5.

For the purpose of the exemplary method, it is assumed that a number of jobs are in a queue and a message, for example, that service is required on the output device, is to be delivered to an appropriate user when a product is output for that user.

Operation of the method begins in step 500 and continues to step 510 where it is determined whether there are any jobs in the queue. If there are no jobs in the queue, the method loops through step 510. If there are jobs in the queue, operation continues to step 520. In step 520, the current job order is determined. Then, in step 530, the first job in the queue is processed. Operation continues to step 540.

In step 540, it is determined whether message delivery is required. The message may be a notification that, for example, service is required on a portion of the network, a user has an important e-mail or voicemail, it is nearing an event entered in a user's schedule, etc. If a message is to be delivered, operation continues to step 550. If there is no message to be delivered, operation jumps to step 570.

In step 550, it is determined whether the user associated with the job to be output has a message attribute. For example, if the message is that the output device is low on toner, the message attribute may be, for example, that the user is a member of the junior authenticated user group. Thus, senior and standard users will not be bothered by service messages. Alternatively, if the message is that a particular user is scheduled to attend a meeting in 5 minutes, the message attribute may be the users identity and the message will only be output to the particular user and/or that particular user's secretary. Accordingly, a user may be reminded of his or her schedule when away from their office.

If the user has a message attribute, operation continues to step 560. If the user does not have a message attribute, operation jumps to step 570. In step 560, the message is delivered to the user. The message may be delivered for example on a device on which the job will be output. For example, an LCD screen on a multi-function device may display the message as the job for the user is output. Or the message may be included as part of an e-mail that includes the output image data. The message may also, for example, be included in an e-mail notifying the user that his or her job is being output on a particular device, especially where that output device is incapable of outputting a message.

In step 570, the current job order is updated. Operation then returns to step 510.

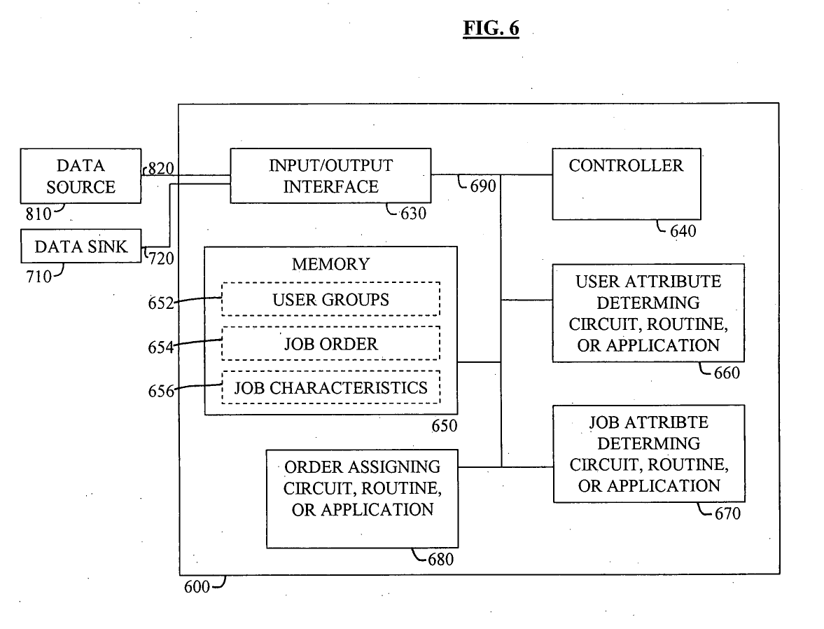

FIG. 6 shows a functional block diagram of an exemplary a system 600 for determining scan job priority that may be used, for example, to implement one or more of the above described exemplary methods. As shown in FIG. 6, the system 600 may be physically, functionally, and/or conceptually divided into an input/output interface 630, a controller 640, a memory 650, a user attribute determining circuit, routine, or application 660, a job attribute determining circuit, routine, or application 670, and/or an order assigning circuit, routine, or application 680, each appropriately interconnected by one or more data/control busses and/or application programming interfaces 690, or the like.

The input/output interface 630 may be connected to one or more data sources 810 over one or more links 820. The data source(s) 810 can be a locally or remotely located scanner, a facsimile device, a xerographic device, a multi-functional imaging device, a device that stores and/or transmits electronic data, such as a client or a server of a wired or wireless network, such as for example, an intranet, an extranet, a local area network, a wide area network, a storage area network, the Internet (especially the World Wide Web), and the like. In general, the data source 810 can be any known or later-developed source that is capable of providing image data captured by a scanning device to the input/output interface 630.

The input/output interface 630 may be connected to one or more data sinks 710 over one or more links 720. The data sink(s) 710 can be a locally or remotely located printer, a facsimile device, a xerographic device, a multi-functional imaging device, a device that stores and/or transmits electronic data, such as a client or a server of a wired or wireless network, such as for example, an intranet, an extranet, a local area network, a wide area network, a storage area network, the Internet (especially the World Wide Web), and the like. In general, the data sink 810 can be any known or later-developed source that is capable of utilizing image data captured by a scanning device to the input/output interface 630.

Each of the various links 820 and 720 may be any known or later-developed device or system for connecting the data source(s) 810 and/or the data sink(s) 710, respectively, to the input/output interface 630. In particular, the links 820 and 720 my each be implemented as one or more of, for example, a direct cable connection, a connection over a wide area network, a local area network or a storage area network, a connection over an intranet, a connection over an extranet, a connection over the Internet, a connection over any other distributed processing network or system, and/or an infrared, radio-frequency or other wireless connection.

As shown in FIG. 6, the memory 600 may be physically, functionally, and/or conceptually divided into a number of different memory portions, including a user groups portion 652, a job order portion 654, and/or a job characteristics portion 656. The user groups portion 652 may store the user group data such as, for example, the different groups and the attributes of the users within the groups. The job order portion 654 may store the current order of the job queue. The job characteristics portion 656 may store one or more characteristics of each job, for example, the user or user type, the user group, the data size, the service type or priority, and/or the processing required.

The memory 650 may be implemented using any appropriate combination of alterable or non-alterable memory, volatile or non-volatile memory, or fixed memory. The alterable memory, whether volatile or non-volatile, can be implemented using any one or more of static or dynamic RAM, a floppy disk and disk drive, a writeable or re-re-writeable optical disk and disk drive, a hard drive, flash memory or the like. Similarly, the non-alterable or fixed memory can be implemented using any one or more of ROM, PROM, EPROM, EEPROM, an optical ROM disk, such as CD-ROM or DVD-ROM disk, and disk drive or the like.

The user attribute determining circuit, routine, or application 660 may input data related to a job and determine or predict various user attributes based on that data. The job attribute determining circuit, routine, or application 670 may input data related to a job and may determine various job attributes. The order assigning circuit, routine, or application 680 may input data related to a job and determine an assign the job an order in the job queue based on the input data, for example, user attributes and job attributes.

For example, in operation, data related to a job (job data) may be input from the data source to the input/output interface 630. Under control of the controller 640, the data may be stored in the job characteristics portion 656 of the memory 650. Alternatively, the job data may be input, under control of the controller 640, directly to the user attribute determining circuit, routine, or application 660. Under control of the controller, the user attribute determining circuit, routine, or application 660 may access the job data and determine or predict user attributes associated with the job data. Under control of the controller 640, the user attributes may be stored in the job characteristics portion 656. Alternatively, the user attributes may be input, under control of the controller 640, directly to the order assigning circuit, routine, or application 680.

The job attribute determining circuit, routine, or application 670 may access the job data and may determine various job attributes. The determined job attributes, under control of the controller 640, may be stored in the job characteristics portion 656. Alternatively, the job attributes may be input, under control of the controller 640, directly into the order assigning circuit, routine, or application 680. The order assigning circuit, routine, or application 680, under control of the controller 640, may access various user attributes and job attributes from the job characteristics portion, the user groups data from the user groups portion 652, and the job order for the queue from the job order portion 654. The order assigning circuit, routine, or application 680 may assign the job a position in the job queue based on the accessed information, for example, according to one or more of the exemplary methods shown in FIGS. 1-4. Under control of the controller 640, the job order, including the newly assigned job position is output by the order assigning circuit, routine, or application 680 and stored in the job order portion 654.

Under control of the controller 640, the job order may be output to the data sink 710 via the input/output interface 630. Accordingly, the job order may be utilized by an image-processing network in order to more efficiently process scanned image data. This may be done, for example, by the exemplary method shown in FIG. 5.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

For example, according to various other exemplary implementations, the job characteristics may be considered before the user characteristics in order to assign the job a position in the job queue.

Furthermore, for example, one or more job characteristics, in addition to the file size, service priority, and processing required, may be considered. The order in which the various job characteristics are considered may be changed.

While the exemplary system has been described as physically, functionally, and/or conceptually divided into a user attribute determining circuit, routine, or application 660, a job attribute determining circuit, routine, or application 670, and/or an order assigning circuit, routine, or application 680, it should be appreciated that one or more of the circuits, routines, or applications may be included in and/or executed by the controller 640.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A method for determining a priority of a job on a network, comprising:
determining at least one user attribute of a user associated with the job; and
assigning the job a priority based on the at least one user attribute;
wherein, the job comprises image data optically captured by a device in communication with the network.

2. The method of claim 1, wherein:
determining the at least one user attribute of a user associated with the job comprises determining whether the user belongs to a predefined group of users.

3. The method of claim 2, wherein:
assigning the job a priority based on the at least one user attribute comprises assigning, if the user belongs to a predefined group, the job a priority based on the predefined group.

4. The method of claim 2, wherein:
determining the at least one user attribute of a user associated with the job comprises determining whether the user belongs to an authenticated group.

5. The method of claim 4, wherein:
assigning the job a priority based on the at least one user attribute comprises assigning, if the user belongs to the authenticated group, the job a priority ahead of jobs in which an associated user does not belong to the authenticated group.

6. The method of claim 1, further comprising:
determining at least one job attribute of the job;
wherein assigning the job a priority based on the at least one user attribute further comprises assigning the job a priority based on the at least one user attribute and the at least one job attribute.

7. The method of claim 6, wherein:
determining the at least one job attribute of the job comprises determining a file size of the job; and
assigning the job a priority based on the at least one user attribute and the at least one job attribute comprises assigning the job a priority based on the file size of the job.

8. The method of claim 6, wherein:
determining the at least one job attribute of the job comprises determining a service priority of the job; and
assigning the job a priority based on the at least one user attribute and the at least one job attribute comprises assigning the job a priority based on the service priority of the job.

9. The method of claim 6, wherein:
determining the at least one job attribute of the job comprises determining an amount of processing required for the job; and
assigning the job a priority based on the at least one user attribute and the at least one job attribute comprises assigning the job a priority based on the amount of processing required for the job.

10. A system for determining a priority of a job on a network, comprising:
a controller that:
determines at least one user attribute of a user associated with the job; and
assigns the job a priority based on the at least one user attribute;
wherein, the job comprises image data optically captured by a device in communication with the network.

11. The system of claim 10, wherein:
the controller determines whether the user belongs to a predefined group of users.

12. The system of claim 11, wherein:
if the user belongs to a predefined group, the controller assigns the job a priority based on the predefined group.

13. The system of claim 11, wherein:
the controller determines whether the user belongs to an authenticated group.

14. The system of claim 13, wherein:
if the user belongs to the authenticated group, the controller assigns the job a priority ahead of jobs in which an associated user does not belong to the authenticated group.

15. The system of claim 10, wherein the controller:
determines at least one job attribute of the job; and
assigns the job a priority based on the at least one user attribute and the at least one job attribute.

16. The system of claim 15, wherein:
the controller determines at least one job attribute of the job comprises determining a file size of the job; and
assigns the job a priority based on the file size of the job.

17. The system of claim 15, wherein:
the controller determines at least one job attribute of the job comprises determining a service priority of the job; and
assigns the job a priority based on the service priority of the job.

18. The system of claim 15, wherein:
the controller determines an amount of processing required for the job; and
assigns the job a priority based on the amount of processing required for the job.

19. A network server comprising the system of claim 15.

20. A storage medium storing a set of program instructions executable on a data processing device and usable to determine a priority of a job on a network, the instructions comprising:
instructions for determining at least one user attribute of a user associated with the job; and
instructions for assigning the job a priority based on the at least one user attribute;
wherein, the job comprises image data optically captured by a device in communication with the network.
